(19) United States
(12) Patent Application Publication
(10) Pub. No.: US 2026/0181592 A1
(43) Pub. Date: Jun. 25, 2026

(54) APPARATUS AND METHOD FOR MANAGING PAGING INFORMATION IN WIRELESS COMMUNICATION SYSTEM

(71) Applicant: Samsung Electronics Co., Ltd., Gyeonggi-do (KR)

(72) Inventors: Kwangjin CHOI, Gyeonggi-do (KR); Dongmyung KIM, Gyeonggi-do (KR); Daejin KIM, Gyeonggi-do (KR)

(21) Appl. No.: 19/407,555

(22) Filed: Dec. 3, 2025

(30) Foreign Application Priority Data
Dec. 20, 2024 (KR) 10-2024-0192952

(51) Int. Cl. H04W 68/02; H04L 49/90

(52) U.S. Cl. CPC H04W 68/02; H04L 49/9026

(57) ABSTRACT

The disclosure relates to a 5G communication system or a 6G communication system for supporting higher data rates beyond a 4G communication system such as long term evolution (LTE). A method performed by a base station may include receiving a paging message from a network node, identifying paging timer information for at least one paging record, determining a valid time of the at least one paging record, based on the identified paging timer information, identifying whether the valid time of the at least one paging record has expired, discarding the at least one paging record, based on identifying that the valid time has expired, and transmitting the at least one paging record stored in a buffer to a user equipment (UE) through a radio interface.

### PRIORITY

This application is based on and claims priority under 35 U.S.C. § 119 to Korean Patent Application No. 10-2024-0192952, filed on Dec. 20, 2024, in the Korean Intellectual Property Office, the disclosure of which is incorporated herein by reference in its entirety.

### BACKGROUND

### 1. Field

The disclosure relates generally to a wireless communication system and, more particularly, to a method and an apparatus for managing paging information in a wireless communication system.

### 2. Description of Related Art

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3THz bands). It is expected that, due to severer path loss and atmospheric absorption in the terahertz bands than those in mm Wave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations s and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

With the development of a communication system, therefore, there is a need in the art for an improved a paging procedure for a UE in a radio resource control (RRC)-inactive state.

### SUMMARY

According to an aspect of the disclosure, a method performed by a base station in a wireless communication system may include receiving a paging message from a network node, identifying paging timer information for at least one paging record, determining a valid time of the at least one paging record, based on the identified paging timer information, identifying whether the valid time of the at least one paging record has expired, discarding the paging record the valid time of which has expired, based on the identifying, and transmitting the paging record stored in a buffer to a user equipment (UE) through a radio interface.

According to an aspect of the disclosure, a method performed by a base station in a wireless communication system may include receiving a paging message from a network node, identifying paging timer information for at least one paging record, determining a valid time of the at least one paging record, based on the identified paging timer information, identifying whether the valid time of the at least one paging record has expired, discarding the at least one paging record, based on identifying that the valid time has expired, and transmitting the at least one paging record stored in a buffer to a user equipment (UE) through a radio interface.

According to an aspect of the disclosure, a base station in a wireless communication system may include at least one transceiver and a controller coupled to the at least one transceiver, wherein the controller may be configured to receive a paging message from a network node, identify paging timer information for at least one paging record; determine a valid time of the at least one paging record, based on the identified paging timer information; identify whether the valid time of the at least one paging record has expired; discard the at least one paging record, based on identifying that the valid time has expired; and transmit the at least one paging record stored in a buffer to a UE through a radio interface.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example in which a plurality of paging messages is transmitted according to an embodiment;

FIG. 2 illustrates an operation in which a paging message is transmitted and received between a base station and a core network node or radio access network (RAN) nodes according to an embodiment;

FIG. 3 illustrates an example in which a base station manages a paging record according to an embodiment;

FIG. 4 illustrates an operation in which a paging message is transmitted and received between a base station and a core network node according to an embodiment;

FIG. 5 illustrates an operation in which an interface setup message is transmitted and received between a base station and a core network node according to an embodiment;

FIG. 6 illustrates an operation in which a paging message or an interface setup message is transmitted and received between RAN nodes according to an embodiment;

FIG. 7 illustrates an operation in which a paging message or an interface setup message is transmitted and received between 6G RAN nodes according to an embodiment;

FIG. 8 illustrates an operation between a base station and a core network node and an operation between RAN nodes according to an embodiment;

FIG. 9 illustrates an operation of a base station according to an embodiment;

FIG. 10 illustrates an operation of a base station according to an embodiment;

FIG. 11 illustrates a structure of a core network (CN) node according to an embodiment;

FIG. 12 illustrates a structure of a base station according to an embodiment; and

FIG. 13 illustrates a structure of a UE according to an embodiment.

### DETAILED DESCRIPTION

Various aspects of the claimed subject matter are now described with reference to the drawings, wherein like reference numerals are used to refer to like elements throughout. In the following description, for the purpose of explanation, numerous specific details are set forth to provide a full understanding of one or more embodiments. It may be apparent, however, that such embodiment(s) may be implemented without these specific details.

The terms used in the disclosure are used merely to describe particular embodiments, and may not be intended to limit the scope of other embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the same meanings as the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

As used herein, terms referring to signals (e.g., message, signal, signaling, sequence, and stream), resources (e.g., symbol, slot, subframe, frame, subcarrier, resource element (RE), resource block (RB), bandwidth part (BWP), and occasion), operations (e.g., step, method, process, and procedure), data (e.g., information, parameter, variable, value, bit, symbol, and codeword), channels, control information (e.g., DL control information (DCI), medium access control control element (MAC CE), and RRC signaling), network entities, device elements, and the like are illustratively used for the sake of descriptive convenience. Therefore, the disclosure is not limited by the terms as described below, and other terms referring to subjects having equivalent technical meanings may be used.

Various embodiments of the disclosure are described herein in connection with a wireless terminal and/or a BS. The wireless terminal may refer to a device providing voice and/or data connectivity to a user. The wireless terminal may be connected to a computing device such as a laptop computer or desktop computer, or it can be a self-contained device such as a personal digital assistant (PDA). The wireless terminal may also be referred to as a system, a subscriber unit, a subscriber station, mobile station, mobile, remote station, access point, remote terminal, access terminal, user terminal, user agent, user device, or UE. The wireless terminal may be a subscriber station, a wireless device, a cellular telephone, a personal communications services (PCS) telephone, a cordless telephone, a session initiation protocol (SIP) phone, a wireless local loop (WLL) station, a personal digital assistant (PDA), a handheld device having wireless connection capability, or other processing device connected to a wireless modem. The BS (e.g., access point) may refer to a device in an access network that communicates over the air-interface, through one or more sectors, with wireless terminals. The BS may act as a router between the wireless terminal and the rest of the access network, which can include an Internet protocol (IP) network, by converting received air-interface frames to IP packets. The BS also coordinates management of attributes for the air interface.

Herein, some of terms and names defined in the 3rd generation partnership project (3GPP)-based communication standards (e.g., standards for 5G, NR, long term evolution (LTE), or similar systems) may be used for the sake of descriptive convenience. However, the disclosure is not limited by these terms and names, and may be applied in the same manner to systems that conform other standards.

In the following description, terms for identifying access nodes and referring to network entities, messages, interfaces between network entities, and various identification information, and the like are illustratively used for the sake of descriptive convenience. Therefore, the disclosure is not limited by the terms as used herein, and other terms referring to subjects having equivalent technical meanings may be used.

The state of a UE (or terminal) may include an RRC-idle state, an RRC-inactive state, or an RRC-connected state depending on how an RAN manages UE-related information. In the RRC-connected state, the UE may transmit and receive service data to and from a BS.

The UE in the RRC-idle state may transmit an RRC SETUP REQUEST message (or RRC configuration request message) to an RAN to start a state transition to the RRC-connected state. The UE in the RRC-inactive state may transmit an RRC RESUME REQUEST message (or RRC resumption request message) to the RAN to start a state transition to the RRC-connected state.

A process in which the RAN or a CN node induces the UE to transmit the RRC SETUP REQUEST message or the RRC RESUME REQUEST message may be referred to as a paging process. In the paging process, messages delivered by the RAN or the CN node to the UE through a BS may be paging messages (or page messages).

An operation in which the UE in the RRC-idle state or RRC-inactive state attempts to transition to the RRC-connected state may be referred to as a mobile originated (MO) operation (or mobile origination), and an operation in which the RAN or the CN node induces the UE in the RRC-idle state or RRC-inactive state to transition to the RRC-connected state may be referred to as a mobile terminated (MT) operation (or mobile termination). In an example, an MT procedure is started by the RAN or the CN node, an operation in which the RAN transmits a paging message is hereinafter referred to as an RAN paging operation, and an operation in which the CN node transmits a paging message is hereinafter referred to as a CN paging operation.

Hereinafter, a paging timer described in the disclosure may be operated a network node transmitting a paging message, and may refer to a waiting time for the paging message. Paging timer information may be time information associated with the paging timer or preconfigured time information not associated with the paging timer.

In an example, the start time and end time of the paging timer may be defined as in Table 1 below.

TABLE 1

| | | Paging | Cause of | | |
|---|---|---|---|---|---|
| | NE | timer | start | Normal stop | On expiry |
| Core | 4G | T3413 | Paging | Paging procedure for EPS services | Network |
| paging | MME | (as in | procedure | completed | dependent |
| | | relevant | for EPS | Paging procedure is aborted | |
| | | standard) | services | | |
| | | | initiated | | |
| | 5G | T3513 | Paging | When an integrity-protected | Network |
| | AMF | (as in | procedure | response is received from the UE | dependent |
| | | relevant | initiated | and successfully integrity checked | |
| | | standard) | | by the network or when the 5GMM | |
| | | | | entity in the AMF receives an | |
| | | | | indication from the lower layer that | |
| | | | | it has received the NGAP UE | |
| | | | | context resume request message as | |
| | | | | specified in the relevant standard | |
| RAN | 5G | — | Paging | RETRIEVE UE CONTEST | Network |
| paging | gNB- | | procedure | REQUEST is received | dependent |
| | CU | | initiated | | |

Hereinafter, a paging record may include a plurality of pieces of paging information included in a paging message. Alternatively, a paging record may refer to a data format converted for transmission to a UE through a radio interface, based on paging information in a paging message received by a BS. The maximum number of paging records (i.e., the maximum number of pageable UEs or paging resources) that may be included in a paging message may be predefined.

Hereinafter, a method for transmitting timer information related to a paging message and discarding data based on the paging message in a wireless mobile communication network system including 4G LTE, 5G NR, or 6G is disclosed.

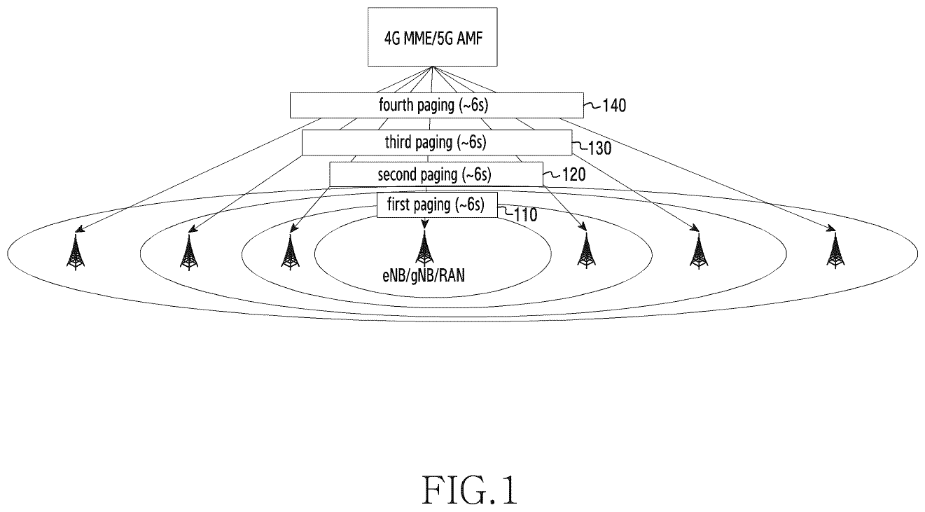

FIG. 1 illustrates an example in which a plurality of paging messages is transmitted according to an embodiment.

Referring to FIG. 1, when a CN paging operation is performed in 4th-generation (4G) LTE, a paging message may be forwarded from a mobility management entity (MME) node to a UE through an eNB. When a CN paging operation is performed in 5G NR, a paging message may be forwarded from an AMF node to a UE through a next-generation radio access network (NG-RAN) (or gNodeB (gNB)). In 5G NR, when the gNB is split into a gNB-CU) and a gNB distributed unit (gNB-DU), a paging message may be transmitted from the gNB-CU to the gNB-DU.

When CN paging or RAN paging is performed, a BS (or gNB-DU) receiving a paging message from a core network node (e.g., the MME node in 4G or the AMF node in 5G) or the gNB-CU may store a paging record for a UE indicated by the paging message in a buffer. The BS may transmit the stored paging record to the UE through a radio interface (air interface) in a paging occasion (PO). The BS may transmit a plurality of paging records, and the number of paging records transmittable in one PO may be limited. The number of paging records transmittable in one PO may vary depending on the type of a UE, a paging configuration, or the type of a radio interface. The UE having received the paging record indicating an identifier of the UE from the BS may transmit an RRC SETUP REQUEST message or an RRC RESUME REQUEST message to the BS to start a transition to the RRC-connected state.

When the 4G MME node, the 5G AMF node, or the gNB-CU transmits a paging message to an eNB, a gNB, or a gNB-DU, respectively, the MME node, the AMF node, or the gNB-CU may operate a paging timer to wait for a response to the transmitted paging message. Hereinafter, a paging timer may refer to a waiting time from when a paging message is transmitted to when a response message to the transmitted paging message is received.

When the MME node, the AMF node, or the gNB-CU receives a response message to the transmitted paging message before the paging timer expires, the paging timer is normally terminated.

When failing to receive the response message to the transmitted paging message before the paging timer expires, the MME node, the AMF node, or the gNB-CU may retransmit a paging message after the paging timer expires, or may perform a different predefined procedure. When a paging timer expires after the 4G MME node or the 5G AMF node transmits a paging message in CN paging, the paging message may be retransmitted to a larger number of BSs (eNBs, gNBs, or RANs) by increasing the range of the paging message. In another example, when a paging timer expires after the gNB-CU transmits a paging message to the gNB-DU in RAN paging, the paging message may be retransmitted by increasing the range of the paging message. The number of times a paging message is retransmitted may be preconfigured.

Although FIG. 1 illustrates a CN paging operation in which the 4G MME node or the 5G AMF node transmits a paging message to the eNB or the gNB, a node that performs the CN paging operation is not limited to the MME node or the AMF node illustrated in FIG. 1, and may be a 6G core network node.

The 4G MME node or the 5G AMF node may transmit a first paging message to a BS (e.g., the 4G eNB or the 5G gNB) in a first paging operation 110. After transmitting the first paging message, the 4G MME node or the 5G AMF node may operate a first paging timer (e.g., 6 seconds(s)). When failing to receive a response message to the paging message from a UE through the UE or the BS until the first paging timer expires (e.g., 6s has passed), the 4G MME node or the 5G AMF node may retransmit a paging message to the BS. The paging message retransmitted after the first paging message may be a second paging message, and the second paging message may be transmitted in a wider range than the range of the first paging message. In a second paging operation 120, the 4G MME node or 5G AMF node may operate a second paging timer (e.g., 6s) after transmitting the second paging message, and may retransmit an additional paging message as a third paging message when failing to receive a response message to the second paging message until the second paging timer expires. The third paging message may be transmitted in a wider range than the range of the second paging message.

In a third paging operation 130, the 4G MME node or the 5G AMF node may perform a fourth paging operation 140 to retransmit a fourth paging message when failing to receive a response message to the third paging message until a third paging timer (e.g., 6s) expires. The fourth paging message may be transmitted in wider reach than the range of the third paging message.

The maximum number of times the 4G MME node or the 5G AMF node retransmits a paging message may be predetermined. For example, the number of times the 4G MME node or the 5G AMF node of FIG. 1 retransmits a paging message may be determined as up to 4. The 4G MME node or the 5G AMF node may retransmit a paging message up to the predetermined maximum number of paging message retransmissions. When retransmitting a paging message up to the predetermined maximum number of paging message retransmissions but failing to receive a response message to the paging message, the 4G MME node or 5G AMF node may terminate a paging operation.

Although not shown in FIG. 1, in RAN paging, the gNB-CU may operate a paging timer while transmitting a paging message to the gNB-DU, and may retransmit a paging message when the gNB-CU fails to receive a response message to the paging message from the gNB-DU until the paging timer expires. The gNB-CU may retransmit a paging message to the gNB-DU as many times as the preset maximum number of paging message retransmissions until receiving a paging response message. In an example, when retransmitting a paging message to the gNB-DU up to the maximum number of paging message retransmissions but failing to receive a response message, the gNB-CU may transmit a UE CONTEXT RELEASE REQUEST message to the AMF node to request UE context release.

When retransmission of a paging message is repeated, if the base station (or the gNB-DU in RAN paging) receiving the paging message receives the paging message to exceed the number of paging records transmittable to the UE through a radio interface (air interface) for a predetermined time, a paging record may wait in the buffer of the base station for a long time, thereby causing paging congestion. When paging congestion is intensified, the base station may not receive any further new paging message due to a buffer overflow. For example, it is assumed that the buffer of the base station receiving a paging message has a capacity to store up to six paging records and the number of paging records that the base station is able to transmit to the UE through the radio interface is limited to one per second (sec) per cell. In this case, when the capacity of the buffer is saturated with six paging records included in a retransmitted paging message received by the base station, new paging messages may be discarded without being received by the base station due to buffer overflow.

As the number of received paging messages increases, waiting time in the buffer of the base station increases, and the waiting time in the buffer of the base station may exceed the waiting time of a paging timer of a core network entity (e.g., the 4G MME node or the 5G AMF node) or an RAN node (e.g., the gNB-CU) transmitting a paging message. In this case, a paging message is retransmitted due to expiration of the paging timer, and thus paging congestion may be further increased.

The UE in the RRC-inactive state or the RRC-idle state may start to transition to the RRC-connected state even when receiving only one of a first transmitted paging message and a retransmitted paging message. However, since both a paging record based on the first transmitted paging message and a paging record based on the retransmitted paging message are left in the buffer of the base station and then transmitted to the UE through the radio interface, radio resources may be unnecessarily wasted. In addition, since the range of a paging message increase as the paging message is retransmitted, a larger number of base stations may receive the paging message than before, thus further increasing paging congestion.

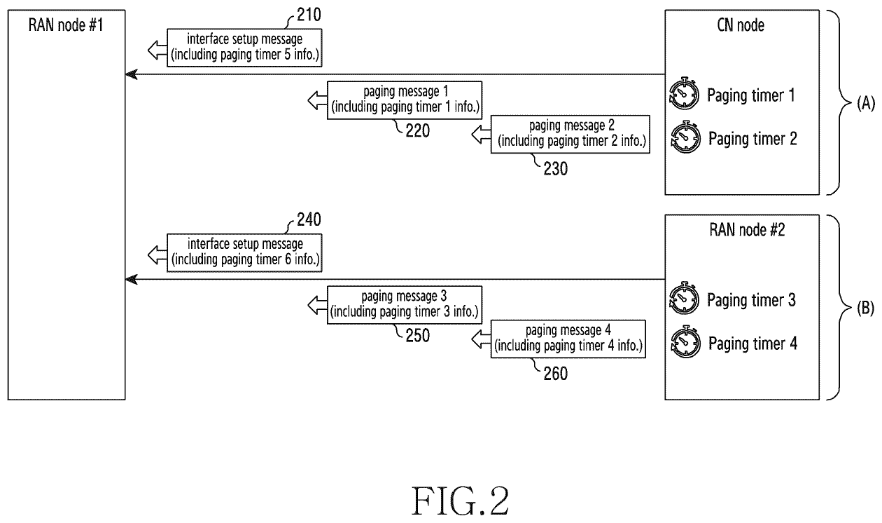

Accordingly, FIG. 2 to FIG. 10 propose a method for managing paging information in a wireless communication system to reduce paging congestion and to prevent unnecessary waste of radio interface resources.

FIG. 2 illustrates an operation in which a paging message is transmitted and received between a BS and a core network node or RAN nodes according to an embodiment.

Referring to FIG. 2, the core network node or the RAN node may include paging timer information when transmitting a paging message. The paging timer information may be included and transmitted in an interface setup message.

Paging timer information described herein may be information about a paging timer described above, and may refer to information about various values expressed based on the operating time of a preconfigured paging timer. Paging timer information may include a time value of a preconfigured paging timer as is. For example, when the operating time of the preconfigured paging timer is 6 seconds, a configured value of 6 seconds for a paging record may be included in the paging timer information. Alternatively, paging timer information may include a value adjusted from a time value of a preconfigured paging timer. For example, when the operating time of the preconfigured paging timer is 6 seconds, the paging timer information may include a configured value of 8 seconds, which is obtained by adding 2 seconds to 6 seconds, or a configured value of 12 seconds, which is twice 6 seconds.

Paging timer information may include an indication value corresponding to a time value of a preconfigured paging timer. For example, when the operating time of the preconfigured paging timer is 3 seconds, information indicating a value of 1 may be included in the paging timer information, and when the operating time of the preconfigured paging timer is 6 seconds, information indicating a value of 2 may be included in the paging timer information.

A value randomly determined irrespective of a time value of a preconfigured paging timer may be included in paging timer information.

Section (A) of FIG. 2 illustrates an operation in which a core network node (e.g., a 4G MME node, a 5G AMF node, or a 6G core network device) transmits a paging message including paging timer information to a BS (e.g., a 4G eNB, a 5G gNB, or a 6G RAN device) to reduce paging congestion.

The core network node may operate a paging timer for CN paging while transmitting the paging message to the BS. When a response message is received within the operating time of the preconfigured timer, the operation of the timer is terminated. When the core network node fails to receive a response message to the paging message from a UE through the BS until the operating time of the paging timer expires, the node having transmitted the paging message may perform an operation, such as retransmission of a paging message. A paging timer of the MME node performing CN paging in 4G is defined in the relevant standard and is referred to as T3413. In another example, a paging timer of an AMF node performing CN paging in 5G is defined in 3GPP TS 24.501, and is referred to as T3513.

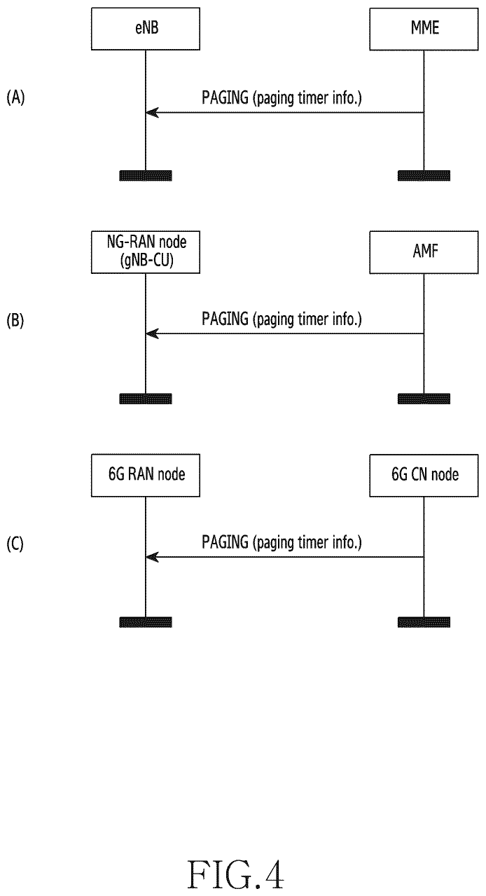

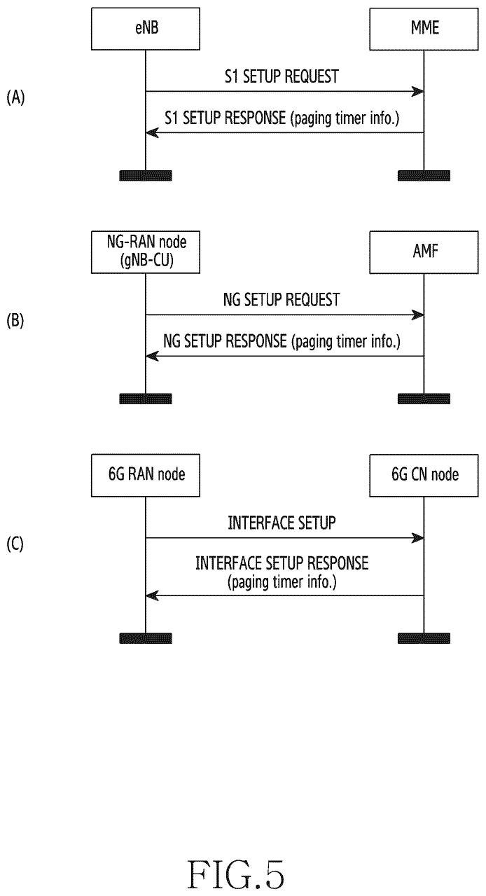

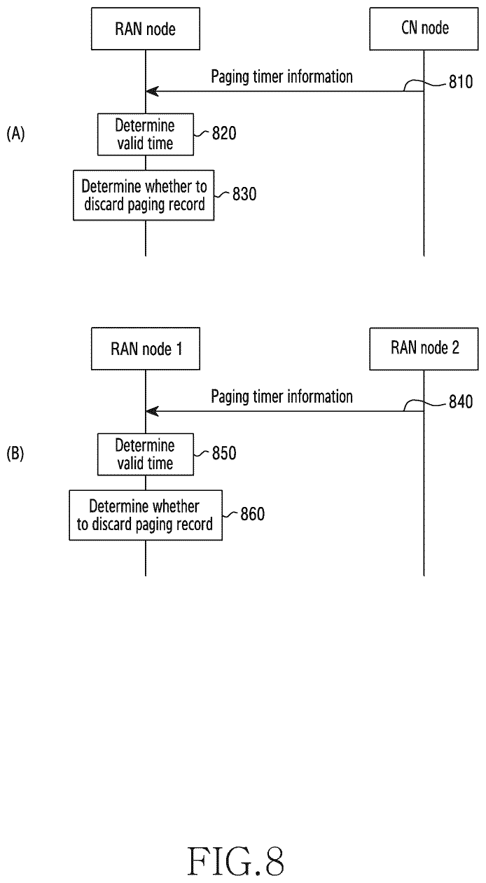

The core network node may transmit the paging timer information to the BS (e.g., RAN node #1 of FIG. 2) by including the same in the paging message (e.g., 220 or 230 in section (A) of FIG. 2), or may transmit the paging timer information to the BS by including the same in an interface setup message (e.g., 210 in section (A) of FIG. 2) between the core network node and the BS. Paging message 1 220 may include paging timer information related to preconfigured paging timer 1 for the core network node, and paging message 2 230 may include paging timer information related to preconfigured paging timer 2. The interface setup message 210 may include paging timer information related to paging timer 5 separately configured, which is not paging timer 1 or paging timer 2 configured for the core network node. The interface setup message between the core network node and the BS includes all messages for exchanging fixed information related to an interface, and is not limited to a specific message. Hereinafter, a specific embodiment in which the core network node transmits paging timer information to the base station in 4G, 5G, or 6G will be described with reference to (A) of FIG. 4, (A) of FIG. 5, and (A) of FIG. 8.

Section (B) of FIG. 2 illustrates an operation of transmitting a paging message between RAN nodes, in which RAN node #2 (e.g., a 5G gNB-CU) transmits a paging message including paging timer information to RAN node #1 (e.g., a 5G gNB-DU).

RAN node #2 may operate a paging timer for RAN paging while transmitting a paging message to RAN node #1, and when a response message is received within the operating time of the preconfigured timer, the operation of the timer is terminated. When RAN node #2 fails to receive a response message to the paging message from the UE through RAN node #1 until the operating time of the paging timer expires, the node having transmitted the paging message may perform an operation, such as retransmission of a paging message. In an example, a paging timer of the gNB-CU performing RAN paging is not separately defined in the relevant standard, but a timer that measures a valid time when a paging message is transmitted in 4G, 5G, and 6G wireless communication systems may also refer to a paging timer.

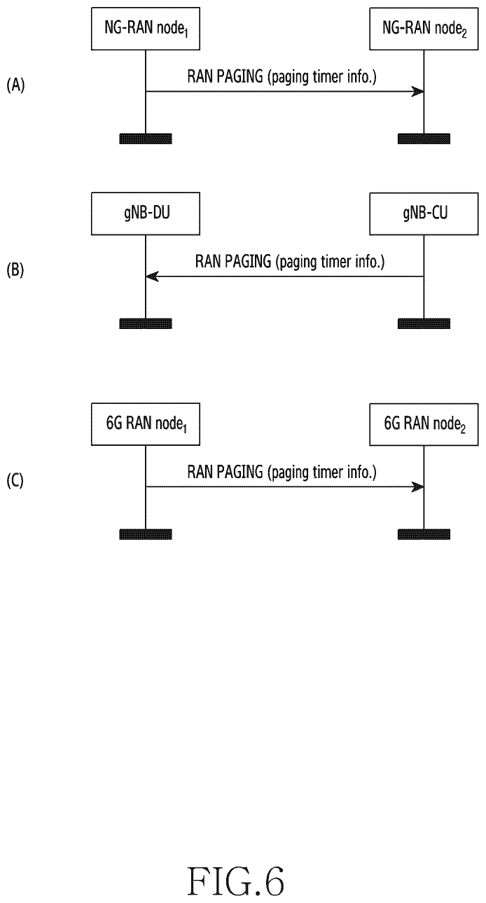

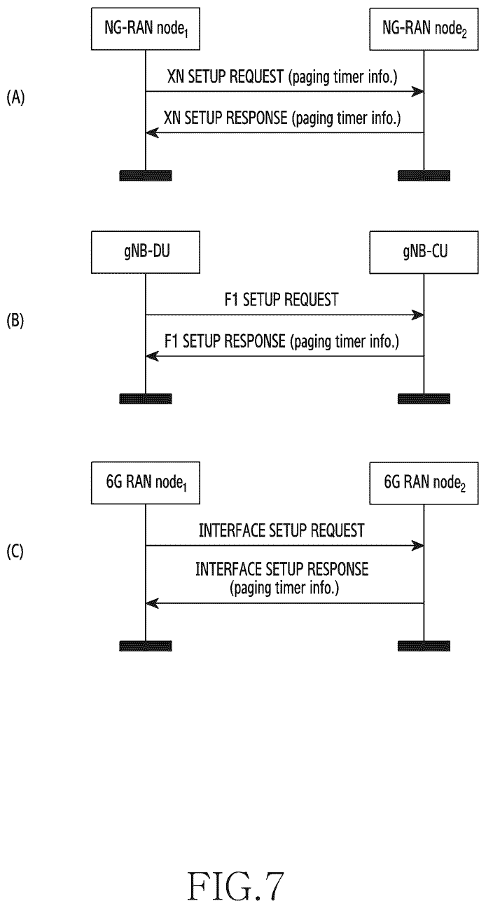

RAN node #2 (e.g., the RAN node) may transmit the paging timer information to another RAN node (e.g., RAN node #1) by including the same in the paging message (e.g., 250 and 260 in section (B) of FIG. 2), or may transmit the paging timer information by including the same in an interface setup message (e.g., 240 in section (B) of FIG. 2) between nodes of the BS. Paging message 3 250 may include paging timer information related to preconfigured paging timer 3 for the core network node, and paging message 4 260 may include paging timer information related to preconfigured paging timer 4. The interface setup message 240 may include paging timer information related to paging timer 6 separately configured, which is not paging timer 3 or paging timer 4 configured for the core network node. The interface setup message between the RAN nodes includes all messages for exchanging fixed information related to an interface, and is not limited to a specific message. Hereinafter, a specific embodiment for transmitting paging timer information between the RAN nodes in 4G, 5G, or 6G will be described with reference to (B) of FIG. 6, (B) of FIG. 7, or (B) of FIG. 8.

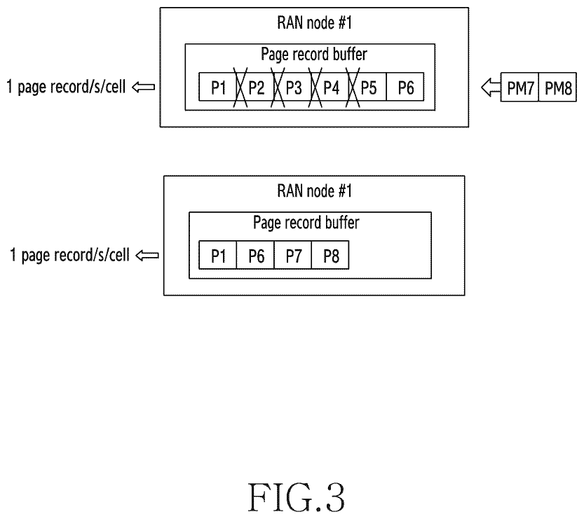

FIG. 3 illustrates an example in which a BS manages a paging record (or page record) according to an embodiment. Referring to FIG. 3, an operation in which the BS of the disclosure discards a paging record in a paging record buffer by using paging timer information is shown.

When the BS receives paging timer information from a core network node or another RAN node, the BS may discard (or delete) a buffered paging record, based on the received paging timer information, before transmitting the same via a radio interface. For example, assuming that RAN node #1 is able to transmit one paging record per second in one cell (1 page record/s/cell) to a UE via the radio interface, RAN node #1 may determine a discard timer for each of buffered page records P1, P2, . . . , and P6, based on the paging timer information, and may delete page records P2, P3, P4, and P5 for which the discard timers have expired from a paging record buffer in RAN node #1. Subsequently, RAN node #1 may not transmit the deleted paging records P2, P3, P4, and P5 through the radio interface, and may receive paging records P7 and P8 included in a new paging message in the remaining space of the paging record buffer.

As described above, the BS receiving paging timer information may separately determine a discard timer for a paging record, based on the paging timer information, and thus a paging record for which a discard timer determined by the BS has expired may be deleted before a device (core network node or RAN node) having transmitted a paging message receives a paging response message, thereby effectively reducing occurrence of congestion in the paging record buffer.

FIG. 4 illustrates an operation in which a paging message is transmitted and received between a BS and a core network node according to an embodiment.

Referring to FIG. 4, section (A) illustrates an operation in which a paging message is transmitted and received between a BS and a core network node, section (B) illustrates an operation in which a paging message is transmitted and received between a BS and a core network node and section (C) illustrates an operation in which a paging message is transmitted and received between a BS and a core network node. Sections (A), (B) and (C) of FIG. 4 illustrate an operation in which the core network node transmits a paging message including paging timer information to the BS.

Section (A) of FIG. 4 illustrates an example in which paging timer information is included in a paging message when an MME node transmits the paging message to an eNB in 4G CN paging.

As in Table 2 below, a definition of paging timer information or a separate clause for paging timer information may be added to an information element (IE) in a paging message defined in the relevant standard.

In Table 2, a paging timer may be added to or be separately defined in the IE included in the paging message.

Section (B) of FIG. 4 illustrates an example in which paging timer information is included in a paging message when an AMF node transmits the paging message to an NG-RAN node (or gNB-CU) in 5G CN paging.

In Table 3 below, a definition of paging timer information or a separate clause for paging timer information may be added to an IE in a paging message defined in the relevant standard.

In Table 3, a paging timer may be added to or be separately defined in the IE included in the paging message.

In addition, according to an embodiment of the disclosure, paging timer information may be added to a paging message transmitted to an RAN when an AMF node performs a CN paging operation in 5G in a network-triggered service request specified in the relevant standard.

Section (C) of FIG. 4 illustrates an example in which paging timer information is included in a paging message when a 6G core network node transmits the paging message to a 6G gNB (6G RAN node) in 6G CN paging.

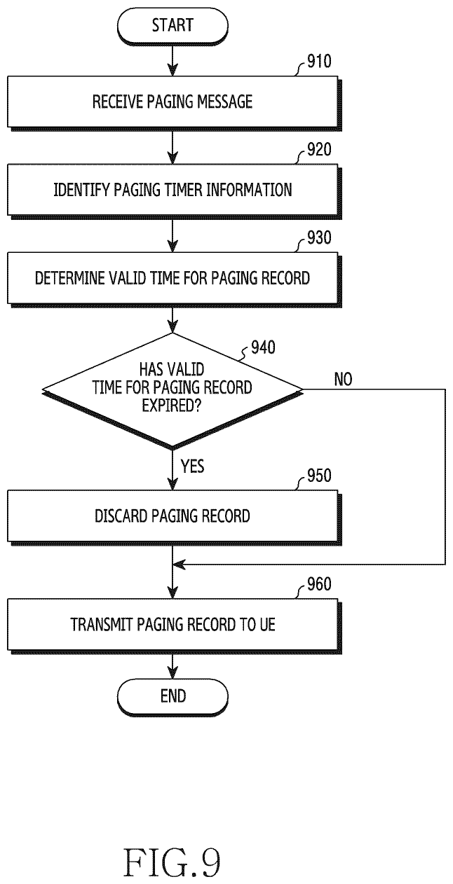

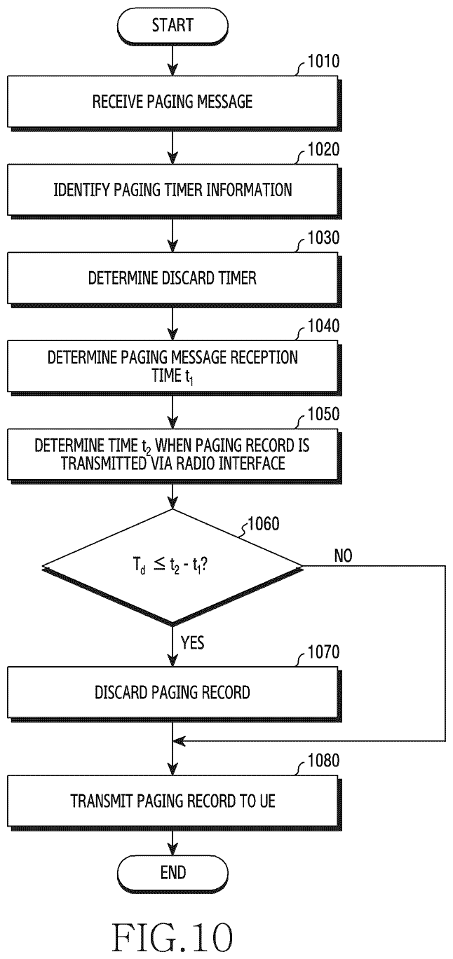

As described above, in 4G, 5G, or 6G, the core network node may include paging timer information when transmitting a paging message to the BS. Accordingly, the BS may identify the paging timer information included in the paging message, and may configure a valid time or a discard timer for a paging record to be transmitted to a UE, thereby performing operations for managing the paging record. Hereinafter, specific operations in which the BS manages a paging record by using received paging timer information will be described in detail with reference to section (A) of FIG. 8, FIG. 9 and FIG. 10.

FIG. 5 illustrates an operation in which an interface setup message is transmitted and received between a BS and a core network node according to an embodiment.

Referring to FIG. 5, section (A) illustrates an operation in which an interface setup message is transmitted and received between a BS and a core network node, section (B) illustrates an operation in which an interface setup message is transmitted and received between a BS and a core network node and section (C) illustrates an operation in which an interface setup message is transmitted and received between a BS and a core network node. The interface setup message may refer to all messages for exchanging information related to an interface, and is not limited to a specific message.

Section (A) illustrates an operation in which an interface setup message is transmitted and received between an MME node and an eNB in 4G CN paging. When the eNB transmits an S1 interface setup request message (S1 SETUP REQUEST message) to the MME node, the MME node may transmit an S1 interface setup response message (S1 SETUP RESPONSE message) including paging timer information to the eNB.

In Table 4 below, a definition of paging timer information or a separate clause for paging timer information may be added to an IE in a interface setup response message defined in 3GPP TS 36.413.

In Table 4, a paging timer may be added to or be separately defined in the IE included in the interface setup response message.

Section (B) of FIG. 5 illustrates an operation in which an interface setup message is transmitted and received between an AMF node and an NG-RAN node (or gNB-CU) in 5G CN paging. When the NG-RAN node transmits an NG interface setup request message (NG SETUP REQUEST message) to the AMF node, the AMF node may transmit an NG interface setup response message (NG SETUP RESPONSE message) including paging timer information to the NG-RAN node.

In Table 5 below, a definition of paging timer information or a separate clause for paging timer information may be added to an IE in a interface setup response message defined in 3GPP TS 38.413.

In Table 5, a paging timer may be added to or be separately defined in the IE included in the interface setup response message.

Section (C) of FIG. 5 illustrates an operation in which an interface setup message is transmitted and received between a 6G core network node and a 6G RAN node in 6G CN paging. When the 6G RAN node transmits an interface setup request message (INTERFACE SETUP message) to the 6G core network node, the 6G core network node may transmit an interface setup response message (INTERFACE SETUP RESPONSE message) including paging timer information to the 6G RAN node.

As described above, in 4G, 5G, or 6G, the core network node may include paging timer information when transmitting an interface setup response message to the BS. Accordingly, the BS may identify the paging timer information included in the interface setup response message, and may configure a valid time or a discard timer for a paging record to be transmitted to a UE, thereby performing operations for managing the paging record.

FIG. 6 illustrates an operation in which a paging message or an interface setup message is transmitted and received between RAN nodes according to an embodiment.

Referring to FIG. 6, section (A) illustrates an operation in which a paging message or an interface setup message is transmitted and received between RAN nodes, section (B) illustrates an operation in which a paging message or an interface setup message is transmitted and received between RAN nodes and section (C) of FIG. 6 illustrates an operation in which a paging message or an interface setup message is transmitted and received between RAN nodes. Specifically, sections (A), (B) and (C) in FIG. 6 illustrate an example in which paging timer information is included in a paging message transmitted and received between RAN nodes.

Section (A) illustrates an operation of including paging timer information in an RAN paging message when NG-RAN node 1 transmits the RAN paging message to NG-RAN node 2 in 5G RAN paging.

In Table 6 below, a definition of paging timer information or a separate clause for paging timer information may be added to an IE in a paging message defined in 3GPP TS 38.423.

In Table 6, a paging timer may be added to or be separately defined in the IE included in the paging message.

Section (B) of FIG. 6 illustrates an operation of including paging timer information in a paging message when a gNB-CU transmits the paging message to a gNB-DU in 5G CN paging or 5G RAN paging. In Table 7 below, a definition of paging timer information or a separate clause for paging timer information may be added to an IE in a paging message defined in the relevant standard.

In Table 7, a paging timer may be added to or be separately defined in the IE included in the paging message.

Section (C) of FIG. 6 illustrates an operation of including paging timer information in an RAN paging message when 6G RAN node 1 transmits the RAN paging message to 6G RAN node 2 in 6G RAN paging.

As described above, when an RAN paging operation is performed between the RAN nodes in 4G, 5G, or 6G, paging timer information may be included in a paging message. Accordingly, a BS receiving the paging message may identify the paging timer information included in the paging message, and may configure a valid time or a discard timer for a paging record to be transmitted to a UE, thereby performing operations for managing the paging record.

FIG. 7 illustrates an operation in which a paging message or an interface setup message is transmitted and received between 6G RAN nodes according to an embodiment.

Referring to FIG. 7, section (A) illustrates an operation in which a paging message or an interface setup message is transmitted and received between 6G RAN nodes, section (B) illustrates an operation in which a paging message or an interface setup message is transmitted and received between 6G RAN nodes and section (C) illustrates an operation in which a paging message or an interface setup message is transmitted and received between 6G RAN nodes. The interface setup message refer to all messages for exchanging information related to an interface, and is not limited to a specific message.

Section (A) illustrates an operation in which an interface setup message is transmitted and received between NG-RAN node 1 and NG-RAN node 2 in 5G RAN paging. When NG-RAN node 1 transmits an XN interface setup request message (XN SETUP REQUEST message) to NG-RAN node 2, NG-RAN node 2 may transmit an XN interface setup response message (XN SETUP RESPONSE message) including paging timer information to NG-RAN node 1.

In Table 8 below, a definition of paging timer information or a separate clause for paging timer information may be added to an IE in a interface setup response message defined in 3GPP TS 38.423.

In Table 8, a paging timer may be added to or be separately defined in the IE included in the interface setup response message.

Section (B) of FIG. 7 illustrates an operation in which an interface setup message is transmitted and received between a gNB-DU and a gNB-CU in 5G RAN paging. When the gNB-DU transmits an F1 interface setup request message (F1 SETUP REQUEST message) to the gNB-CU, the gNB-CU may transmit an F1 interface setup response message (F1 SETUP RESPONSE message) including paging timer information to the gNB-DU.

In Table 9 below, a definition of paging timer information or a separate clause for paging timer information may be added to an IE in a interface setup response message defined in 3GPP TS 38.473.

In Table 9, a paging timer may be added to or be separately defined in the IE included in the interface setup response message.

Section (C) of FIG. 7 illustrates an operation in which an interface setup message is transmitted and received between 6G RAN node 1 and 6G RAN node 2 in 6G RAN paging. When 6G RAN node 1 transmits an interface setup request message (INTERFACE REQUEST message) to 6G RAN node 2, 6G RAN node 2 may transmit an interface setup response message (INTERFACE RESPONSE message) including paging timer information to 6G RAN node 1.

As described above, when an interface setup operation is performed between the RAN nodes in 4G, 5G, or 6G, paging timer information may be included in an interface setup response message. Accordingly, an RAN node receiving the interface setup response message may identify the paging timer information included in the interface setup response message, and may configure a valid time or a discard timer for a paging record to be transmitted to a UE, thereby performing operations for managing the paging record.

FIG. 8 illustrates an operation between a BS and a core network node and an operation between RAN nodes according to an embodiment.

Referring to FIG. 8, section (A) illustrates an operation between a BS and a core network node.

, In step 810, the core network node may transmit paging timer information to the BS through a paging message or an interface setup response message. For example, referring to FIG. 4 to FIG. 5, the paging timer information may be included in the paging message or the interface setup response message, and may be transmitted from the core network entity to the BS.

The BS having received the paging timer information from the core network node may store a paging record per UE in a buffer, based on the information included in the received paging message.

In step 820, the BS may determine a valid time for the paging record stored in the buffer. Specifically, the BS may determine the valid time for the paging record before transmitting the paging record to the UE through a radio interface. The valid time for the paging record may indicate a time for which the paging record is validly stored in the buffer of the BS.

The valid time for the paging record may be determined based on the paging timer information included in the received paging message or the paging timer information included in the interface setup response message.

The BS may determine the valid time for the paging record to be the same value as a time value included in the received paging timer information. For example, when the time value included in the paging timer information is 6 seconds (sec), the valid time for the paging record may be determined to be 6 seconds.

The BS may determine the valid time for the paging record by using a time value included in the received paging timer information and an adjusting value. For example, when the time value included in the paging timer information is 6 seconds, the valid time for the paging record may be determined to be 8 seconds obtained by adding 2 seconds to 6 seconds, or may be randomly adjusted to 12 seconds, which is twice 6 seconds.

The BS may determine the valid time for the paging record to be a configured value corresponding to a time value included in the received paging timer information. The configured value may be predetermined to correspond to a specific time value. For example, when the time value included in the paging timer information is 1, the BS may determine 3 seconds corresponding to predetermined 1 as the valid time for the paging record. Alternatively, when the time value included in the paging timer information is 2, the BS may determine 6 seconds corresponding to predetermined 2 as the valid time for the paging record.

Even though receiving the paging timer information, the BS may determine a preconfigured random time value as the valid time for the paging record irrespective of the received paging timer information. For example, even though a time value included in the paging timer information included in the received paging message is 3 seconds, the BS may a preconfigured time value of 60 seconds as the valid time for the paging record.

The valid time for the paging record may be determined based on a predefined value for a valid time even though no paging timer information is included in the received paging message.

In step 830, the BS may determine whether to discard the paging record. Before transmitting the paging record stored in the buffer to the UE through the radio interface, the BS may determine whether the valid time for the paging record determined has expired in step 820.

When a valid time for a specific paging record from a time when a paging message is received has expired, the BS may determine to discard the paging record stored in the buffer. The paging record may be discarded even when the paging timer operated by the core network node having transmitted the paging message related to the discarded paging record is still running.

The BS may configure a discard timer for each paging record stored in the buffer, based on the valid time determined in step 820. The BS may configure the determined valid time as a start value of the discard timer, and may operate the discard timer for each paging record. Accordingly, the BS may discard a paging record for which an operated discard timer has expired. The start value of the discard timer for each paging record may be determined based on a preconfigured time value instead of the valid time determined in step 820.

When determining whether to discard the paging record by configuring the discard timer for each paging record, if the start value (hereinafter, T_{d}) of the discard timer is a time value less than or equal to a difference between a time (hereinafter, t₂) when the paging record stored in the buffer is transmitted through the radio interface and a time (hereinafter, t₁) when the paging message is received (i.e., T_{d}≤t₂−t₁), the paging record may be discarded without being transmitted through the radio interface.

Section (B) of FIG. 8 illustrates an operation between RAN nodes.

In step 840, RAN node 2 (e.g., a gNB-CU) may transmit paging timer information to RAN node 1 through a paging message or an interface setup response message. For example, referring to FIG. 6 to FIG. 7, the paging timer information may be included in the paging message or the interface setup response message, and may be transmitted from RAN node 2 to RAN node 1 (e.g., gNB-DU).

The RAN node 1 having received the paging timer information from the RAN node 2 may store a paging record per UE in a buffer, based on the information included in the received paging message.

In step 850, RAN node 1 may determine a valid time for the paging record stored in the buffer. Specifically, RAN node 1 may determine the valid time for the paging record before transmitting the paging record to the UE through a radio interface. The valid time for the paging record may indicate a time for which the paging record is validly stored in the buffer of the BS.

The valid time for the paging record may be determined based on the paging timer information included in the received paging message or the paging timer information included in the interface setup response message.

RAN node 1 may determine the valid time for the paging record to be the same value as a time value included in the received paging timer information. For example, when the time value included in the paging timer information is 6 seconds, the valid time for the paging record may be determined to be 6 seconds.

RAN node 1 may determine the valid time for the paging record by using a time value included in the received paging timer information and an adjusting value. For example, when the time value included in the paging timer information is 6 seconds, the valid time for the paging record may be determined to be 8 seconds obtained by adding 2 seconds to 6 seconds, or may be randomly adjusted to 12 seconds, which is twice 6 seconds.

RAN node 1 may determine the valid time for the paging record to be a configured value corresponding to a time value included in the received paging timer information. The configured value may be predetermined to correspond to a specific time value. For example, when the time value included in the paging timer information is 1, the BS may determine 3 seconds corresponding to predetermined 1 as the valid time for the paging record. Alternatively, when the time value included in the paging timer information is 2, RAN node 1 may determine 6 seconds corresponding to predetermined 2 as the valid time for the paging record.

Even though receiving the paging timer information, RAN node 1 may determine a preconfigured random time value as the valid time for the paging record irrespective of the received paging timer information. For example, even though a time value included in the paging timer information included in the paging message received by RAN node 1 from RAN node 2 is 3 seconds, a preconfigured time value of 60 seconds may be determined as the valid time for the paging record.

The valid time for the paging record may be determined based on a predefined value for a valid time even though no paging timer information is included in the received paging message.

In step 860, RAN node 1 may determine whether to discard the paging record. Before transmitting the paging record stored in the buffer to the UE through the radio interface, RAN node 1 may determine whether the valid time for the paging record determined has expired in step 850.

When a valid time for a specific paging record from a time when a paging message is received by RAN node 1 from RAN node 2 has expired, RAN node 1 may determine to discard the paging record stored in the buffer. In this case, a paging timer operated by RAN node 2 having transmitted the paging message related to the discarded paging record is still running, the paging record may be discarded.

RAN node 1 may configure a discard timer for each paging record stored in the buffer, based on the valid time determined in step 850. RAN node 1 may configure the determined valid time as a start value of the discard timer, and may operate the discard timer for each paging record. Accordingly, RAN node 1 may discard a paging record for which an operated discard timer has expired. The start value of the discard timer for each paging record may be determined based on a preconfigured time value instead of the valid time determined in step 850.

When determining whether to discard the paging record by configuring the discard timer for each paging record, if the start value (T_{d}) of the discard timer is a time value less than or equal to a difference between a time (t₂) when the paging record stored in the buffer is transmitted through the radio interface and a time (t₁) when the paging message is received (i.e., T_{d}≤t₂−t₁), the paging record may be discarded without being transmitted through the radio interface.

In FIG. 8, a BS may determine whether to discard a paging record and discard the paging record before transmitting the paging record through a radio interface, thereby efficiently using limited radio interface resources. The BS may autonomously determine whether to discard a paging record stored in a buffer and discard the paging message before a node having transmitted the paging message receives a response message to the paging message, thus effectively reducing the possibility that paging congestion occurs due to a buffer capacity overflow.

FIG. 9 illustrates an operation of a BS according to an embodiment.

Referring to FIG. 9, in step 910, the BS may receive a paging message (or page message) from a network node. The paging message may be a message that an RAN or a core network node transmits to a UE through the BS in CN paging or RAN paging. The network node may refer to the core network node (e.g., a 4G MME node or a 5G AMF node) or the RAN node (e.g., a gNB-CU).

In step 920, the BS may identify paging timer information.

The paging timer information may be information associated with a paging timer operated by the network node (e.g., an MME node, an AMF node, or a gNB-CU) having transmitted the paging message. That is, the paging timer information may refer to information indicating various times expressed based on the operating time of a preconfigured paging timer. The paging timer information may include a time value of a preconfigured paging timer as is. For example, when the operating time of the preconfigured paging timer is 6 seconds, a configured value of 6 seconds for a paging record may be included in the paging timer information. The paging timer information may include a value adjusted from the time value of the preconfigured paging timer. When the operating time of the preconfigured paging timer is 6 seconds, the paging timer information may include a configured value of 8 seconds, which is obtained by adding 2 seconds to 6 seconds, or a configured value of 12 seconds, which is twice 6 seconds.

The paging timer information may include an indication value corresponding to the time value of the preconfigured paging timer. For example, when the operating time of the preconfigured paging timer is 3 seconds, information indicating a value of 1 may be included in the paging timer information, and when the operating time of the preconfigured paging timer is 6 seconds, information indicating a value of 2 may be included in the paging timer information.

A value randomly determined irrespective of the time value of the preconfigured paging timer may be included in the paging timer information.

The paging timer information may indicate time information preconfigured without being associated with the paging timer.

The paging timer information may be transmitted by being included in the paging message received in step 910. However, the disclosure is not limited thereto, and the paging timer information may be included in an interface setup message for configuring an interface between the BS and the network node.

The paging timer information may be preconfigured without being included in the paging message or interface setup message.

In step 930, the BS may determine a valid time for a paging record. The BS may indicate a converted data format to forward data included in the paging message received in step 910 to the UE. The valid time for the paging record may indicate a time for which the paging record is validly stored in a buffer of the BS. The paging record may be stored in the buffer in the BS.

The BS may determine the valid time for each paging record, based on the paging timer information identified in step 920.

The BS may determine the valid time for the paging record to be the same value as a time value included in the received paging timer information. For example, when the time value included in the paging timer information is 6 seconds (sec), the valid time for the paging record may be determined to be 6 seconds.

The BS may determine the valid time for the paging record by using a time value included in the received paging timer information and an adjusting value. When the time value included in the paging timer information is 6 seconds, the valid time for the paging record may be determined to be 8 seconds obtained by adding 2 seconds to 6 seconds, or may be randomly adjusted to 12 seconds, which is twice 6 seconds.

The BS may determine the valid time for the paging record to be a configured value corresponding to a time value included in the received paging timer information. The configured value may be predetermined to correspond to a specific time value. For example, when the time value included in the paging timer information is 1, the BS may determine 3 seconds corresponding to predetermined 1 as the valid time for the paging record. Alternatively, when the time value included in the paging timer information is 2, the BS may determine 6 seconds corresponding to predetermined 2 as the valid time for the paging record.

Even though receiving the paging timer information, the BS may determine a preconfigured random time value as the valid time for the paging record irrespective of the received paging timer information. For example, even though a time value included in the paging timer information included in the received paging message is 3 seconds, the BS may a preconfigured time value of 60 seconds as the valid time for the paging record.

The valid time for the paging record may be determined based on a predefined value for a valid time even though no paging timer information is included in the received paging message.

In step 940, the BS may determine whether the valid time for each paging record has expired. Specifically, the BS may determine whether the valid time for the paging record determined in step 930 has expired before transmitting the paging record stored in the buffer to the UE through a radio interface.

Step 950 is performed when the valid time for the paging record has expired, and step 960 is performed when the valid time for the paging record has not expired.

When a valid time for a specific paging record has expired from a time when the paging message is received has expired, the BS may determine to discard the paging record stored in the buffer in step 950. The paging record may be discarded even when the paging timer operated by the core network node having transmitted the paging message related to the discarded paging record is still running.

In step 960, the BS may transmit a paging record remaining in the buffer without being discarded to the UE through the radio interface (e.g., an air interface). The transmitted paging record may be a paging record for which a valid time have not expired and which is left in the buffer.

Through the foregoing operations, the BS may determine whether the valid time for each paging record stored in the buffer of the BS has expired and discard some paging records even before the paging timer operate by the network node having transmitted the paging message expires. Accordingly, the BS may prevent a congestion situation which may occur due to a buffer capacity overflow in the BS before the paging timer expires, and may provide a buffer capacity margin for receiving a new paging record. In addition, unnecessary buffer capacity usage and wireless resource consumption that occurs due to accumulation of paging messages and transmission of a duplicated paging record via the radio interface when the paging message is repeatedly retransmitted relying only on the paging timer operated by the network node having transmitted the paging message without considering the valid time for the paging record may be effectively solved.

FIG. 10 illustrates a method of a BS according to an embodiment. Specifically, FIG. 10 illustrates an operation of determining whether to discard a paging record by using a discard timer for the paging record in addition to FIG. 9.

Referring to FIG. 10, step 1010 is the same as step 910 of FIG. 9 and step 1020 is the same as step 920 of FIG. 9, and thus a detailed description thereof will be omitted.

The BS may determine a valid time for a paging record subsequently. The BS may indicate a converted data format to forward data included in a paging message received in step 1010 to a UE. The valid time for the paging record may indicate a time for which the paging record is validly stored in a buffer of the BS. The paging record may be stored in the buffer in the BS

The BS may determine a validity time for each paging record, based on paging timer information identified in step 1020.

The BS may determine the valid time for the paging record to be the same value as a time value included in the received paging timer information. For example, when the time value included in the paging timer information is 6 seconds (sec), the valid time for the paging record may be determined to be 6 seconds.

The BS may determine the valid time for the paging record by using a time value included in the received paging timer information and an adjusting value. For example, when the time value included in the paging timer information is 6 seconds, the valid time for the paging record may be determined to be 8 seconds obtained by adding 2 seconds to 6 seconds, or may be randomly adjusted to 12 seconds, which is twice 6 seconds.

The BS may determine the valid time for the paging record to be a configured value corresponding to a time value included in the received paging timer information. The configured value may be predetermined to correspond to a specific time value. For example, when the time value included in the paging timer information is 1, the BS may determine 3 seconds corresponding to predetermined 1 as the valid time for the paging record. Alternatively, when the time value included in the paging timer information is 2, the BS may determine 6 seconds corresponding to predetermined 2 as the valid time for the paging record.

Even though receiving the paging timer information, the BS may determine a preconfigured random time value as the valid time for the paging record irrespective of the received paging timer information. For example, even though a time value included in the paging timer information included in the received paging message is 3 seconds, the BS may a preconfigured time value of 60 seconds as the valid time for the paging record.

The valid time for the paging record may be determined based on a predefined value for a valid time even though no paging timer information is included in the received paging message.

In step 1030, the BS may determine a discard timer. The BS may configure a discarding timer for each paging record to determine whether to discard the paging record.

In step 1040, the BS may determine a reception time (hereinafter, t₁) of the paging message. Specifically, the BS may determine a time when the paging message is received from a network node (e.g., a 4G MME node, a 5G AMF node, or a gNB-CU) in step 1010 as t₁.

In step 1050, the BS may determine a transmission time (hereinafter, t₂) when the paging record is transmitted through a radio interface. Specifically, the BS may determine a transmission time when the paging record stored in the buffer is expected to be transmitted to the UE through the radio interface as t₂.

In step 1060, the BS may determine whether the start value (hereinafter, T_{d}) of the discard timer is a time value less than or equal to a difference between the time (hereinafter, t₂) when the paging record stored in the buffer is transmitted through the radio interface and the time (hereinafter, t₁) when the paging message is received (i.e., T_{d}≤t₂−t₁). The BS may perform operation 1070 for a paging record corresponding to T_{d}≤t₂−t₁, and may perform operation 1080 for a paging record not corresponding to T_{d}≤t₂−t₁.

The BS may configure the valid time for each paging record as the start value of the discard timer. However, the start value of the discard timer for each paging record may be determined based on a preconfigured time value instead of the determined valid time.

In step 1070, when the start value Ta of the discard timer is the time value less than or equal to the difference between the time t₂ when the paging record stored in the buffer is transmitted through the radio interface and the time t₁ when the paging message is received (i.e., T_{d}≤t₂−t₁), the BS may discard the paging record without transmitting the same through the radio interface.

In step 1080, the BS may transmit a paging record remaining in the buffer without being discarded to the UE through the radio interface (e.g., an air interface). The transmitted paging record may be a paging record for which a valid time have not expired and which is left in the buffer.

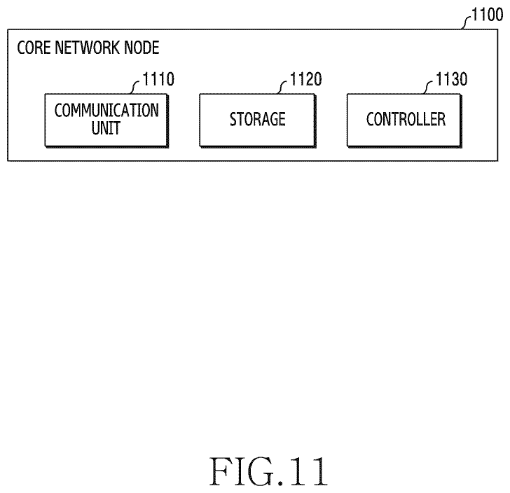

FIG. 11 illustrates a structure of a core network node (or entity) according to an embodiment.

Referring to FIG. 11, the core network node may include a processor (controller) 1120 which controls the overall operation of the core network node, a transceiver (communication unit) 1110 which includes a transmitter and a receiver, and a memory 1120. The example given above is not limiting, and the core network node may include fewer or more components than the components illustrated in FIG. 11.

The transceiver 1110 may transmit/receive signals with at least one of other network entities or UEs. The signals transmitted/received with at least one of other network entities or UEs may include control information and data.

The processor 1130 may control the core network node to perform the operation according to any one of the above-described embodiments. The processor 1130, the memory 1120, and the transceiver 1110 are not necessarily implemented as separate modules, but may be implemented as a single component unit such as a single chip. The processor 1130 and the transceiver 1110 may be electrically connected to each other. The processor 1130 may be an application processor (AP), a communication processor (CP), a circuit, an application-specific circuit, or at least one processor.

The memory 1120 may store basic programs, application programs, and data, such as configuration information, for the operation of the core network node. In particular, the memory 1120 provides the stored data at the request of the processor 1130. The memory 1120 may include storage media such as a read only memory (ROM), a random access memory (RAM), a hard disk, a CD-ROM, and a DVD, or a combination of storage media. The memory 1120 may include multiple memories. The processor 1130 may perform the above-described embodiments of the disclosure, based on the programs for performing the embodiments, stored in the memory 1120.

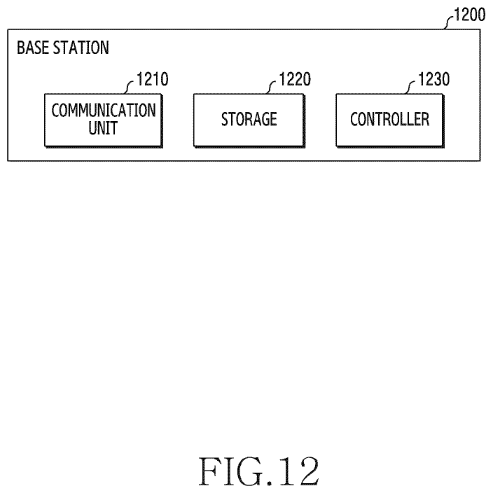

FIG. 12 illustrates a structure of a BS 1200 according to an embodiment.

Referring to FIG. 12, a BS 1200 includes a communication unit 1210, a storage 1220, and a controller 1230.

The communication unit 1210 performs functions for transmitting/receiving signals through a radio channel. The communication unit 1210 performs functions of conversion between baseband signals and bitstrings according to the physical layer specifications of the system. During data transmission, the communication unit 1210 generates complex symbols by encoding and modulating a transmission bitstream. During data reception, the communication unit 1210 demodulates and decodes a baseband signal to restore a received bitstring. The wireless communication unit 1210 up-converts a baseband signal to an RF band signal, transmits the up-converted RF band signal via an antenna, and then down-converts the RF band signal received via the antenna to a baseband signal.

To this end, the wireless communication unit 1210 may include a transmission filter, a reception filter, an amplifier, a mixer, an oscillator, a digital to analog converter (DAC), an analog to digital converter (ADC), and the like. The communication unit 1210 may include multiple transmission/reception paths. Furthermore, the wireless communication unit 1210 may include at least one antenna array including multiple antenna elements. In terms of hardware, the wireless communication unit 1210 may include a digital unit and an analog unit, and the analog unit may include multiple sub-units according to operation power, frequencies, etc.

The communication unit 1210 may transmit/receive signals. To this end, the communication unit 1210 may include at least one transceiver. For example, the communication unit 1210 may transmit a synchronization signal, a reference signal, system information, a message, control information, data, or the like. The communication unit 1210 may perform beamforming.

The communication unit 1210 transmits and receives signals as described above. Accordingly, all or part of the communication unit 1210 may be referred to as a transmitter, a receiver, or a transceiver. In addition, as used in the following description, the meaning of transmission and reception performed through a radio channel includes the meaning that the above-described processing is performed by the communication unit 1210.

The storage 1220 may store basic programs, application programs, and data, such as configuration information, for the operation of the BS. The storage 1220 may include a memory. The storage 1220 may include a volatile memory, a nonvolatile memory, or a combination of a volatile memory and a nonvolatile memory. The storage 1220 provides the stored data at the request of the controller 1230.

The controller 1230 controls the overall operation of the BS 1200. For example, the controller 1230 transmits/receives signals through the communication unit 1210. The controller 1230 records data in the storage 1220 and reads the data from the storage 1220. The controller 1230 may perform functions of protocol stacks required by communication specifications. To this end, the controller 1230 may include at least one processor.

The structure of the BS 1200 illustrated in FIG. 12 is a merely an example of the BS, and examples of the BS for performing various embodiment of the disclosure are not limited to the structure illustrated in FIG. 12. That is, some components may be added, omitted, or changed according to various embodiments.

In FIG. 12, the BS 1200 has been described as a single node, but the disclosure is not limited thereto. In addition to the integrated deployment, the BS 1200 according to various embodiments of the disclosure may be implemented to construct an access network having a distributed deployment. According to an embodiment, the BS may be divided into a central unit (CU) and a digital unit (DU), the CU may be implemented to perform upper layer functions (e.g., packet data convergence protocol (PDCP) and RRC), and the DU may be implemented to perform lower layer functions (e.g., medium access control (MAC) and physical (PHY)). The DU of the BS may form beam coverage on a radio channel.

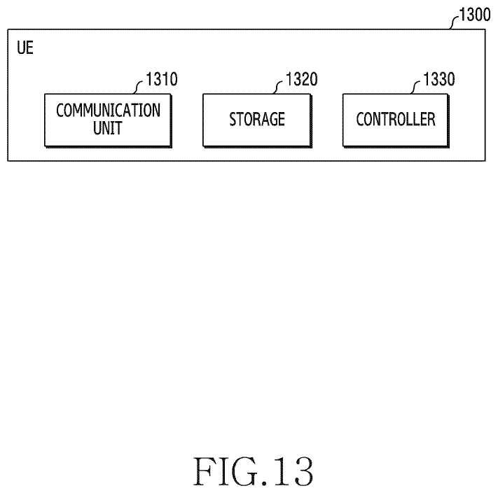

FIG. 13 illustrates a structure of a UE 1300 according to various embodiments of the disclosure.

The configuration illustrated in FIG. 13 may be understood as a configuration of the UE 1300. As used below, such terms as “ . . . unit” and “ . . . device” refer to a unit configured to process at least one function or operation, and may be implemented as hardware, software, or a combination of hardware and software.

Referring to FIG. 13, the UE may include a communication unit 1310, a storage 1320, and a controller 1330.

The communication unit 1310 performs functions for transmitting/receiving signals through a radio channel. For example, the communication unit 1310 performs functions of conversion between baseband signals and bitstrings according to the physical layer specifications of the system. For example, during data transmission, the communication unit 1310 generates complex symbols by encoding and modulating a transmission bitstream. In addition, during data reception, the communication unit 1310 demodulates and decodes a baseband signal to restore a received bitstring. The communication unit 1310 up-converts a baseband signal to an RF band signal, transmits the same through an antenna, and down-converts an RF band signal received through the antenna to a baseband signal. For example, the communication unit 1310 may include a transmission filter, a reception filter, an amplifier, a mixer, an oscillator, a DAC, and an ADC.

The communication unit 1310 may include multiple transmission/reception paths. Furthermore, the communication unit 1310 may include an antenna unit. The communication unit 1310 may include at least one antenna array configured by multiple antenna elements. In terms of hardware, the communication unit 1310 may include a digital circuit and an analog circuit (e.g., radio frequency integrated circuit (RFIC)). The digital circuit and the analog circuit may be implemented as a single package. The communication unit 1310 may include multiple RF chains. The communication unit 1310 may perform beamforming. To assign directivity based on configurations of the controller 1330 to a signal to be transmitted/received, the communication unit 1310 may apply a beamforming weight to the signal. The communication unit 1310 may include a radio frequency (RF) block (or RF unit). The RF block may include first RF circuitry related to antennas and second RF circuitry related to baseband processing. The first RF circuitry may be referred to as an RF-antenna (RF-A). The second RF circuitry may be referred to as an RF-baseband (RF-B).

The communication unit 1310 may transmit/receive signals. To this end, the communication unit 1310 may include at least one transceiver. The communication unit 1310 may receive a DL signal including a synchronization signal (SS), a reference signal (RS) (e.g., demodulation (DM)-RS or phase tracking reference signal (PTRS)), system information (e.g., MIB, SIB, remaining system information (RMSI), or other system information (OSI)), a configuration message, control information, DL data, or the like. The communication unit 1310 may transmit an UL signal. The UL signal may include a random access-related signal (e.g., random access preamble (RAP) (or message 1 (Msg1), message 3 (Msg3)), a reference signal (e.g., sounding reference signal (SRS), DMRS, or PTRS), a power headroom report (PHR), or the like.

The communication unit 1310 may include different communication modules for processing signals in different frequency bands. Furthermore, the communication unit 1310 may include multiple communication modules to support multiple different radio access techniques. For example, different radio access technologies may include Bluetooth low energy (BLE), wireless fidelity (Wi-Fi), Wi-Fi gigabyte (WiGig), cellular networks (e.g., LTE), NR, and the like. In addition, different frequency bands may include super high frequency (SHF) (e.g., 2.5 GHz and 5 GHz) bands and millimeter (mm) wave (e.g., 38 GHz, 60 GHz, etc.) bands. The communication unit 1310 may use a radio-access technology of the same scheme on different frequency bands (e.g., an unlicensed band for licensed assisted access (LAA) and a citizen broadband radio service (CBRS) (e.g., 3.5 GHz)).

The communication unit 1310 transmits and receives signals as described above. Accordingly, all or part of the communication unit 1310 may be referred to as a transmitter, a receiver, or a transceiver. In addition, as used in the following description, the meaning of transmission and reception performed through a radio channel includes the meaning that the above-described processing is performed by the communication unit 1310.

The storage 1320 may store basic programs, application programs, and data, such as configuration information, for operation of the main BS. The storage 1320 may include a volatile memory, a nonvolatile memory, or a combination of a volatile memory and a nonvolatile memory. The storage 1320 provides the stored data at the request of the controller 1330.

The controller 1330 controls overall operations of the UE 1300. For example, the controller 1330 transmits/receives signals through the communication unit 1310. The controller 1330 records data in the storage 1320 and reads the data from the storage 1320. The controller 1330 may perform functions of protocol stacks required by communication specifications. To this end, the controller 1330 may include at least one processor. The controller 1330 may include at least one processor or micro-processor, or may be a part of a processor. In addition, a part of the communication unit 1310 and the controller 1330 may be referred to as a communication processor (CP). The controller 1330 may include various modules for performing communication. According to various embodiments, the controller 1330 may control the UE so as to perform various operations according to various embodiments.

The embodiments of the disclosure described and shown in the specification and the drawings are merely particular examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary.

As described above, a method performed by a BS in a wireless communication system according to various embodiments disclosed herein may include receiving a paging message from a network node, identifying paging timer information about at least one paging record, determining a valid time for the at least one paging record, based on the identified paging timer information, identifying whether the valid time for the at least one paging record has expired, discarding a paging record for which a valid time has expired, based on the identifying, and transmitting a paging record stored in a buffer to a UE through a radio interface.

The at least one paging record may indicate a data format generated based on the paging message, and the at least one paging record may be stored in the buffer in the BS.

The paging timer information may indicate time information associated with a waiting time for the paging message, or may indicate time information preconfigured irrespective of the waiting time for the paging message.

The paging timer information may be included in the paging message, or may be included in an interface setup message, and the interface setup message may be related to an interface between the BS and the network node, or may be related to an interface between a distributed unit (DU) of the BS and a central unit (CU) of the BS.

The valid time for the at least one paging record may be determined based on the paging timer information, or may be predetermined.

When the valid time for the at least one paging record has not expired, the paging record for which the valid time has not expired may be transmitted to the UE through the radio interface.

The identifying whether the valid time for the at least one paging record has expired may include configuring a discard timer for each of the at least one paging record, operating the discard timer for each of the at least one paging record, and discarding the paging record for which the operated discard timer has expired.

A start value of the discard timer may be configured to the determined valid time, or may be predetermined.

The paging record may be discarded when a start value of the discard timer for each of the at least one paging record is less than or equal to a difference between a first time when the paging message is received and a second time when the paging record is transmitted through the radio interface after the first time.

The network node may be an AMF node, MME node, or a CU of the BS.

As described above, BS in a wireless communication system according to various embodiments disclosed herein may include at least one transceiver and a controller coupled with the at least one transceiver, wherein the controller may be configured to: receive a paging message from a network node; identify paging timer information about at least one paging record; determine a valid time for the at least one paging record, based on the identified paging timer information; identify whether the valid time for the at least one paging record has expired; discard a paging record for which a valid time has expired, based on the identifying; and transmit a paging record stored in a buffer to a UE through a radio interface.

The at least one paging record may indicate a data format generated based on the paging message, and the at least one paging record may be stored in the buffer in the BS.

The paging timer information may indicate time information associated with a waiting time for the paging message, or may indicate time information preconfigured irrespective of the waiting time for the paging message.

The paging timer information may be included in the paging message, or may be in an interface setup message, and the interface setup message may be related to an interface between the BS and the network node, or may be related to an interface between a distributed unit (DU) of the BS and a central unit (CU) of the BS.

The valid time for the at least one paging record may be determined based on the paging timer information, or may be predetermined.

When the valid time for the at least one paging record has not expired, the paging record for which the valid time has not expired may be transmitted to the UE through the radio interface.

The controller may be configured to: configure a discard timer for each of the at least one paging record; operate the discard timer for each of the at least one paging record; and discard the paging record for which the operated discard timer has expired.

A start value of the discard timer may be configured to the determined valid time, or may be predetermined.

The paging record may be discarded when a start value of the discard timer for each of the at least one paging record is less than or equal to a difference between a first time when the paging message is received and a second time when the paging record is transmitted through the radio interface after the first time.

The network node may be an AMF node, an MME node, or a CU of the BS.

While the present disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a base station in a wireless communication system, the method comprising:
receiving a paging message from a network node;
identifying paging timer information for at least one paging record;
determining a valid time of the at least one paging record, based on the identified paging timer information;
identifying whether the valid time of the at least one paging record has expired;
discarding the at least one paging record, based on identifying that the valid time has expired; and
transmitting the at least one paging record stored in a buffer to a user equipment (UE) through a radio interface.

2. The method of claim 1, wherein the at least one paging record indicates a data format generated based on the paging message, and
wherein the at least one paging record is stored in the buffer within the base station.

3. The method of claim 1,
wherein the paging timer information indicates time information associated with a waiting time for the paging message, or indicates time information preconfigured irrespective of the waiting time for the paging message.

4. The method of claim 1,
wherein the paging timer information is included in the paging message, or is included in an interface setup message, and
wherein the interface setup message is related to an interface between the base station and the network node, or is related to an interface between a distributed unit (DU) of the base station and a central unit (CU) of the base station.

5. The method of claim 1,
wherein the valid time of the at least one paging record is predetermined.

6. The method of claim 1,
wherein, in case that the valid time of the at least one paging record has not expired, the at least one paging record is transmitted to the UE through the radio interface.

7. The method of claim 1, wherein identifying whether the valid time of the at least one paging record has expired comprises:
configuring a discard timer for each of the at least one paging record;
operating the discard timer for each of the at least one paging record; and
discarding the at least one paging record for which the operated discard timer has expired.

8. The method of claim 7,
wherein a start value of the discard timer is configured as the determined valid time, or is predetermined.

9. The method of claim 7,
wherein, in case that a start value of the discard timer for each of the at least one paging record is less than or equal to a difference between a first time when the paging message is received and a second time when the at least one paging record is transmittable through the radio interface after the first time, the at least one paging record is discarded.

10. The method of claim 1,
wherein the network node includes an access and mobility management function (AMF) node, a mobility management entity (MME) node, or a central unit (CU) of the base station.

11. A base station in a wireless communication system, the base station comprising:
at least one transceiver; and
a controller coupled to the at least one transceiver,
wherein the controller is configured to:
receive a paging message from a network node,
identify paging timer information for at least one paging record,
determine a valid time of the at least one paging record, based on the identified paging timer information,
identify whether the valid time of the at least one paging record has expired;
discard the at least one paging record, based on identifying that the valid time has expired, and
transmit the at least one paging record stored in a buffer to a user equipment (UE) through a radio interface.

12. The base station of claim 11,
wherein the at least one paging record indicates a data format generated based on the paging message, and
wherein the at least one paging record is stored in the buffer within the base station.

13. The base station of claim 11,
wherein the paging timer information indicates time information associated with a waiting time for the paging message, or indicates time information preconfigured irrespective of the waiting time for the paging message.

14. The base station of claim 11,
wherein the paging timer information is included in the paging message, or is included in an interface setup message, and
wherein the interface setup message is related to an interface between the base station and the network node, or is related to an interface between a distributed unit (DU) of the base station and a central unit (CU) of the base station.

15. The base station of claim 11,
wherein the valid time of the at least one paging record is predetermined.

16. The base station of claim 11,
wherein, in case that the valid time of the at least one paging record has not expired, the at least one paging record is transmitted to the UE through the radio interface.

17. The base station of claim 11, wherein the controller is further configured to:
configure a discard timer for each of the at least one paging record;
operate the discard timer for each of the at least one paging record; and
discard the at least one paging record for which the operated discard timer has expired.

18. The base station of claim 17,
wherein a start value of the discard timer is configured as the determined valid time, or is predetermined.

19. The base station of claim 17,
wherein, in case that a start value of the discard timer for each of the at least one paging record is less than or equal to a difference between a first time when the paging message is received and a second time when the at least one paging record is transmittable through the radio interface after the first time, the at least one paging record is discarded.

20. The base station of claim 11,
wherein the network node refers to an access and mobility management function (AMF) node, a mobility management entity (MME) node, or a central unit (CU) of the base station.
